(19) United States
(12) Patent Application Publication
(10) Pub. No.: US 2010/0230516 A1
(43) Pub. Date: Sep. 16, 2010

(54) MIXING NOZZLE FOR PLURAL COMPONENT MATERIALS

(76) Inventors: JOHN B. SOLIE, Stillwater, OK (US); MARVIN L. STONE, Stillwater, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/723,425

(22) Filed: Mar. 12, 2010

Related U.S. Application Data
(60) Provisional application No. 61/159,594, filed on Mar. 12, 2009.

(51) Int. Cl. B05B 7/26

(52) U.S. Cl. 239/428; 239/433

(57) ABSTRACT

A low pressure plural component mixing nozzle for mixing plural component materials for coating the interior of small diameter conduits. A body defines a first passageway that extends from a right to a left side. The body further defines a second passageway communicating an inlet side with the first passageway proximate the right side and defining a third passageway communicating the inlet side with the first passageway proximate the left side. A fourth passageway passes through the body from the inlet side to the exit side. A mixer, such as a mixing cartridge, is located in the first passageway for mixing a fluid from the second passageway and a fluid from the third passageway and directing a mixture of the fluids into contact with fluid flowing through the fourth passageway wherein the mixture flows to an exit nozzle on a distal end of the body stem for exiting the device.

### CROSS REFERENCE TO RELATED APPLICATIONS

This application claims the priority of U.S. Provisional Patent Application No. 61/159,594 entitled “MIXING NOZZLE FOR PLURAL COMPONENT MATERIALS,” filed Mar. 12, 2009, the contents of which are hereby incorporated by reference.

### STATEMENT REGARDING FEDERALLY SPONSORED RESEARCH OR DEVELOPMENT

This invention was made with government support under NSF grant No. EEC-0332723 awarded by the National Science Foundation. The government has certain rights in the invention.

### FIELD OF THE INVENTION

The invention relates to a mixing nozzle for mixing plural component materials. In particular, the invention relates to a low pressure nozzle for mixing plural component materials wherein the device may be used to dispense fluids in small diameter conduits.

### BACKGROUND OF THE INVENTION

Polyurea coatings are ideal for sealing and lining air ducts and other tubes and pipes. However, there are difficulties associated with mixing nozzles used to apply plural compounds to the interior of small, e.g., 4 to 6 inch ID, pipes. Existing mixing and application devices fall into one of two categories: high pressure guns and low pressure nozzles with static mixing tubes. Known guns are too large and their spray patterns are typically small diameter, for application to pipe interiors. Further, high pressure applicators are expensive to purchase and maintain. Furthermore, high pressure applicators may run at pressures of 2000 to 4000 psi, which raises safety concerns. Static mixing tubes used in low pressure systems must be changed each time the application is halted. No known nozzles are available for applying a plural compound mixture to pipe interior walls. Therefore, it is desirable to provide a device that is capable of mixing polyurea and other elastomers at low pressure and that is capable of applying the mixture to the interiors of small diameter pipes. It is further desirable that the device be self-cleaning and have no moving parts.

### SUMMARY OF THE INVENTION

In one embodiment, the device of the invention utilizes two opposed passages to impinge two fluid components, e.g., elastomer or polyurea components, on each other. The fluid components are extruded at high velocity through slots or, alternatively, through a ring orifice oriented perpendicular to the impinging fluid components. Width of the slots is preferably 0.013 ( 1/32) inch wide. Width of the orifice is preferably 0.010 to 0.020 inches. In the ring orifice embodiment, the thickness of the two fluid disks created by fluid passing through the ring orifice decreases to approximately half the orifice width as the disk expands radially. In another embodiment, a mixing tube defines the two opposed passages. Each passage delivers its contents to a plurality of quasi-radial mixing ports that exit from common radial ports. The fluid is dispersed radially through the common radial ports to form a circular pattern that will be referred to herein as a fluid disk.

A high velocity air jet fractures the disk into fine droplets. The droplets are conveyed by an air stream to a small diameter passage in a nozzle. Droplets of the two components are further mixed in this passage. The three fluid mixture, i.e., air or gas and the two mixed fluids, exits radially from the nozzle core at the face of a circular deflector attached to the nozzle core. In one embodiment, these streams impinge on a chamfered edge of the nozzle barrel and circular deflector to form an expanding radial cone of the three fluids. The apex angle of the cone can be varied from 90 to 180 degrees. In another embodiment, the stream exits radially from overlapping slots defined by a nozzle barrel. The conical three fluid stream impinges on the interior surface of the duct or pipe for coating the pipe.

The device blends the fluid components instantaneously at low operating pressures. The device incorporates a third fluid, e.g., air, and produces very small droplets from a highly viscous material. Because of the orientation and incorporation of the air stream, the nozzle is self-cleaning. A conical or disk spray pattern can be formed because the stream is high velocity and consists of three fluids. The air or gas stream entrains the droplets, e.g., of a polyurea mixture, accelerating their velocity, and distributing the droplets in the conical or disk pattern.

In another embodiment, the device uses an auger-like device to mix two fluids as the fluids traverse a length of a mixing tube. The mixed fluids are then further mixed in a mixing area with a third fluid, e.g., air, before the three fluids are dispersed out of spray slits.

In a third embodiment, the device utilizes a third fluid, e.g., that may be delivered via a round or slot shaped section of a fourth passageway to pass over dispersing slots of a mixing cartridge. The air or gas stream entrains the droplets, e.g., of a polyurea mixture, accelerating their velocity, and distributing the droplets in the conical or disk pattern.

### BRIEF DESCRIPTION OF THE DRAWINGS

FIG. 1 is a perspective view of a plural component three fluid/atomizing mixing nozzle.

FIG. 2 is a sectional view of the plural component three fluid mixing/atomizing nozzle of FIG. 1.

FIG. 3 is a sectional view of an alternate embodiment of the plural component three fluid atomizing/mixing nozzle of the invention.

FIG. 4 is a perspective view of the mixing tube of the embodiment of FIG. 3.

FIG. 5 is a partial cut-away perspective view of an embodiment of FIG. 3.

FIG. 6 is a cross-sectional elevation view of the embodiment of FIG. 5.

FIG. 7 is a cross-sectional perspective view of an alternate embodiment of the plural component three fluid atomizing/mixing nozzle of the invention with 4-segment slot orifice nozzle having overlapping slots.

FIG. 8 is a cross-sectional elevation view of the embodiment of the plural component three fluid atomizing/mixing nozzle of the invention of FIG. 7.

FIG. 9A is an isometric view of the mixing cartridge of the embodiment of FIGS. 7 and 8.

FIG. 9B is a cut-away view of the mixing cartridge of the embodiment of FIGS. 7 and 8.

FIG. 10A is a cut-away view of the body of the mixing nozzle of FIGS. 7 and 8 showing an oval shaped aperture for focusing an air stream.

FIG. 10B is a cut-away view of the body of the mixing nozzle of FIGS. 7 and 8 showing a round air stream passageway.

FIG. 11A is a perspective view of a nozzle tip having overlapping slots.

FIG. 11B is a cut-away view of a nozzle tip having overlapping slots.

FIG. 12A is a perspective view of a nozzle tip having a helical slot.

FIG. 12B is a cut-away view of a nozzle tip having a helical slot.

### DETAILED DESCRIPTION OF THE PREFERRED EMBODIMENTS

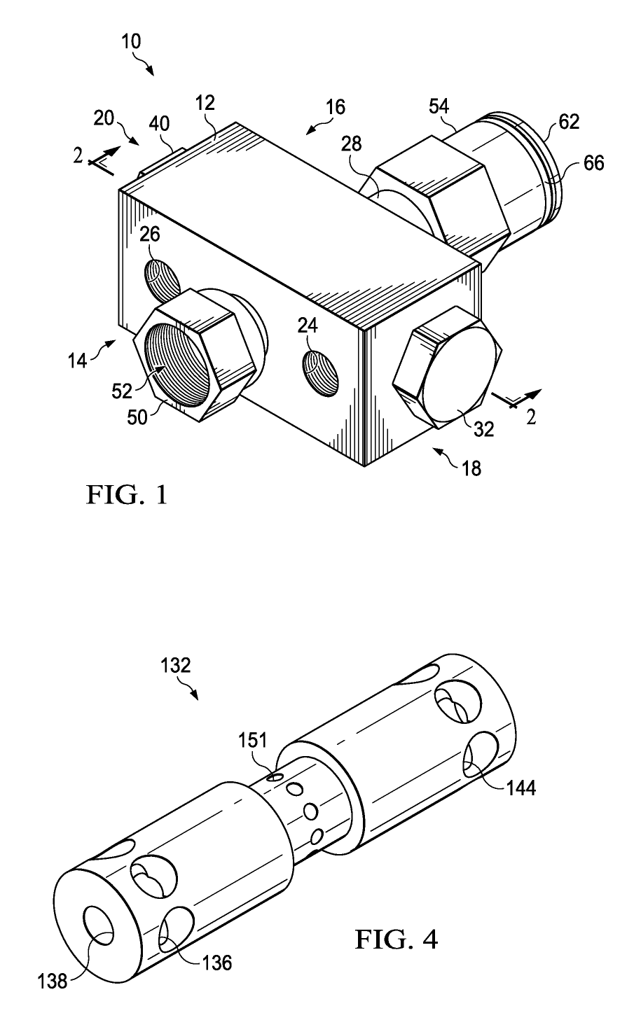

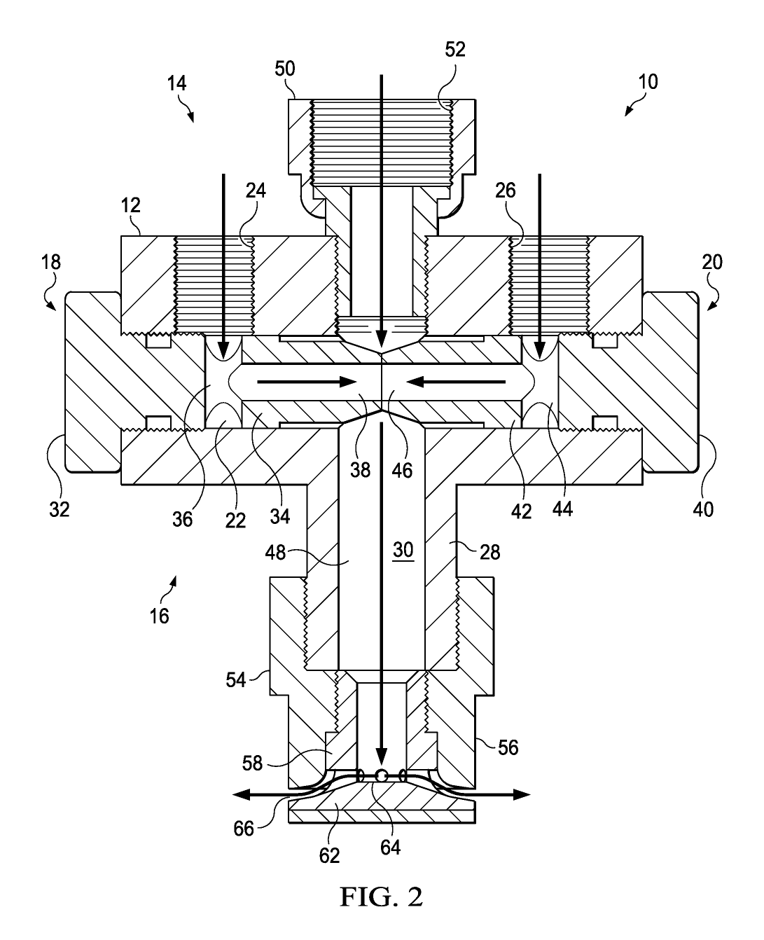

Referring now to FIGS. 1 and 2, shown is a plural component mixing nozzle designated generally 10. Nozzle 10 is made up of a body 12, having an inlet side 14, an exit side 16, a right side 18 and a left side 20. Body 12 defines a first passageway 22 (FIG. 2) that extends from right side 18 to left side 20. Body 12 further defines a second passageway 24 that communicates inlet side 14 with first passageway 22 proximate right side 18. Body 12 further defines a third passageway 26 that communicates inlet side 14 with a first passageway 22 proximate left side 20.

Body stem 28 extends from exit side 16 of body 12. Body 12 and body stem 28 define a fourth passageway 30 (FIG. 2) that passes through body stem 28 and body 12.

Right plug 32 is received in first passageway 22 at right side 18 of body 12. Right plug 32 has a stem 34 that defines a circumferential passageway 36. As shown in FIG. 2, when right plug 32 is inserted into first passageway 22, circumferential passageway 36 communicates with second passageway 24. Right plug 32 further defines a longitudinal passageway 38 (FIG. 2) that communicates with circumferential passageway 36 at a first end of longitudinal passageway 38 and communicates with a distal end of stem 34 at a second end of longitudinal passageway 38.

Left plug 40 is received in first passageway 22 at left side 20 of body 12. Left plug 40 has a stem 42 (FIG. 2) that defines a circumferential passageway 44. When left plug 40 is inserted in first passageway 22, circumferential passageway 44 communicates with third passageway 26. Left plug 40 further defines a longitudinal passageway 46. Longitudinal passageway 46 communicates with circumferential passageway 44 at a first end of longitudinal passageway 46 and communicates with a distal end of stem 42 at a second end of longitudinal passageway 46.

When right plug 32 and left plug 40 are installed within first passageway 22, distal end of stem 34 of right plug 32 and distal end of stem 42 of left plug 40 are located adjacent one another in fourth passageway 30 to define a ring orifice 48 (FIG. 2). In a preferred embodiment, ring orifice 48 is formed by distal ends of stems 34, 42 spaced apart from one another by a distance of between 0.005 and 0.025 inches.

Center member 50 is received in fourth passageway 30 on inlet side 14 of body 12. Center member 50 defines a center fluid inlet 52 for delivering a fluid into fourth passageway 30 for flowing past ring orifice 48.

A nozzle sleeve 54 is threadably received on a distal end of body stem 28. Nozzle sleeve 54 preferably has a tapered outlet end 56. Nozzle barrel member 58 (FIG. 2) is received within nozzle sleeve 54.

A circular deflector 62 is received proximate an outside end of nozzle sleeve 54. Circular deflector 62 defines a plurality of radial orifices 64 (FIG. 2) that communicate an inside of nozzle barrel member 58 with an inside surface of a flange portion of circular deflector 62. The inside surface of the flange portion of circular deflector 62 and the tapered outlet end 56 of nozzle sleeve 54 define a circumferential spray gap 66 for receiving fluids from the plurality of radial orifices 64 and dispersing the fluids in a conical spray configuration.

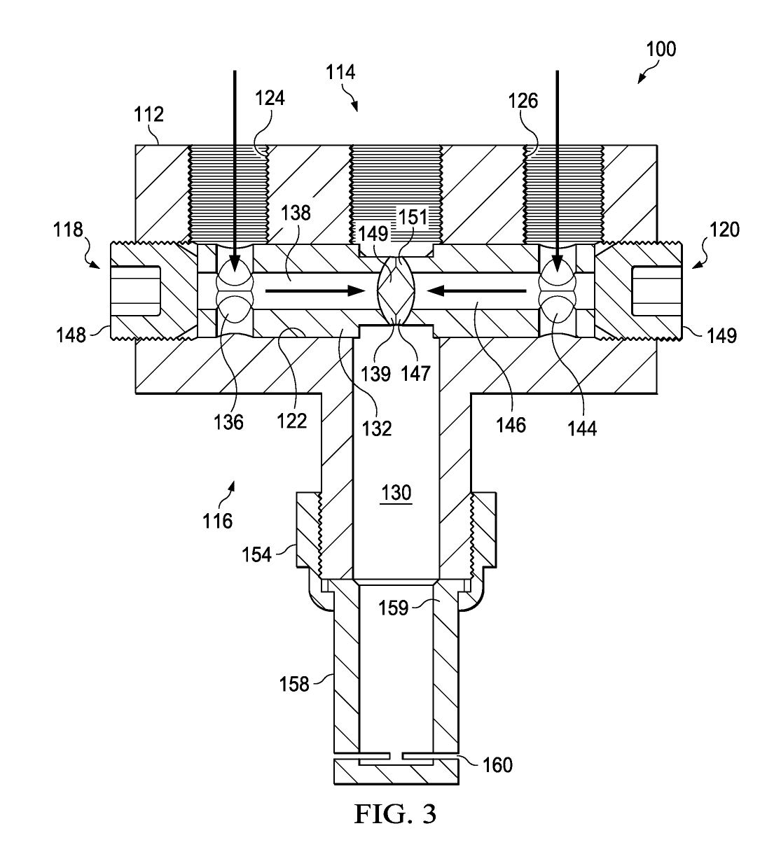

Referring now to FIG. 3, shown is an alternate embodiment of a plural mixing nozzle, designated generally 100. Nozzle 100 is made up of a body 112, having an inlet side 114, an exit side 116, a right side 118, and a left side 120. Body 112 defines a first passageway 122 (FIG. 3) that extends from right side 118 to left side 120. Body 112 further defines a second passageway 124 that communicates inlet side 114 with first passageway 122 proximate right side 118. Body 112 further defines a third passageway 126 that communicates inlet side 114 with a first passageway 122 proximate left side 120.

Body stem 128 extends from exit side 116 of body 112. Body 112 and body stem 128 define a fourth passageway 130 (FIG. 3) that passes through body stem 128 and body 112.

An atomizing and blending cartridge, referred to herein as mixing cartridge 132 (FIGS. 3, 4) is received in first passageway 122. Mixing cartridge 132 defines a right circumferential passageway 136. As shown in FIG. 3, when mixing cartridge 132 is inserted into first passageway 122, right circumferential passageway 136 communicates with second passageway 124. Mixing cartridge 132 further defines a right longitudinal passageway 138 (FIGS. 3, 4) that communicates with circumferential passageway 136 proximate a first end of longitudinal passageway 138 and communicates with a first plurality of quasi-radial passageways 139 proximate a center of mixing cartridge 132 at a second end of longitudinal passageway 138. In a preferred embodiment, twelve quasi-radial passageways 139 are drilled at a 30° angle from a plane that is perpendicular to the longitudinal axis of mixing cartridge 132.

Mixing cartridge 132 defines a left circumferential passageway 144 (FIGS. 3, 4). When mixing cartridge 132 is inserted in first passageway 122, left circumferential passageway 144 communicates with third passageway 126. Mixing cartridge 132 further defines a left longitudinal passageway 146 (FIG. 3). Left longitudinal passageway 146 communicates with circumferential passageway 144 proximate a first end of left longitudinal passageway 146 and communicates with a second plurality of quasi-radial passageways 147 (FIG. 3) proximate a center of mixing cartridge 132 at a second end of longitudinal passageway 146. In a preferred embodiment, twelve quasi-radial passageways 139 are drilled at a 30° angle from a plane that is perpendicular to the longitudinal axis of mixing cartridge 132. Longitudinal passageway 138 and longitudinal passageway 146 are separated from one another by partition 149.

Right stopper 148 and left stopper 149 are secured at right and left ends of first passageway 122 to secure mixing cartridge 132 within first passageway 122 of body 112. Right plurality of quasi-radial passageways 139 and left plurality of quasi-radial passageways 147 meet at common exit orifices defined by an external surface of mixing cartridge 132, i.e., at center mixing ports 151 (FIGS. 3, 4), which distribute mixed fluid radially from mixing cartridge 132 in a quasi-disk pattern. The common mixing ports 151, fed from passageways 139, 147, assure that components flowing through longitudinal passageways 138 and 146 are blended in a 50:50 ratio. Further mixing and conveyance by the air stream is similar to those described in the first embodiment.

Fluid enters into fourth passageway 130 proximate inlet side 114 for flowing past the fluid disk pattern formed by fluid exiting from center mixing ports 151.

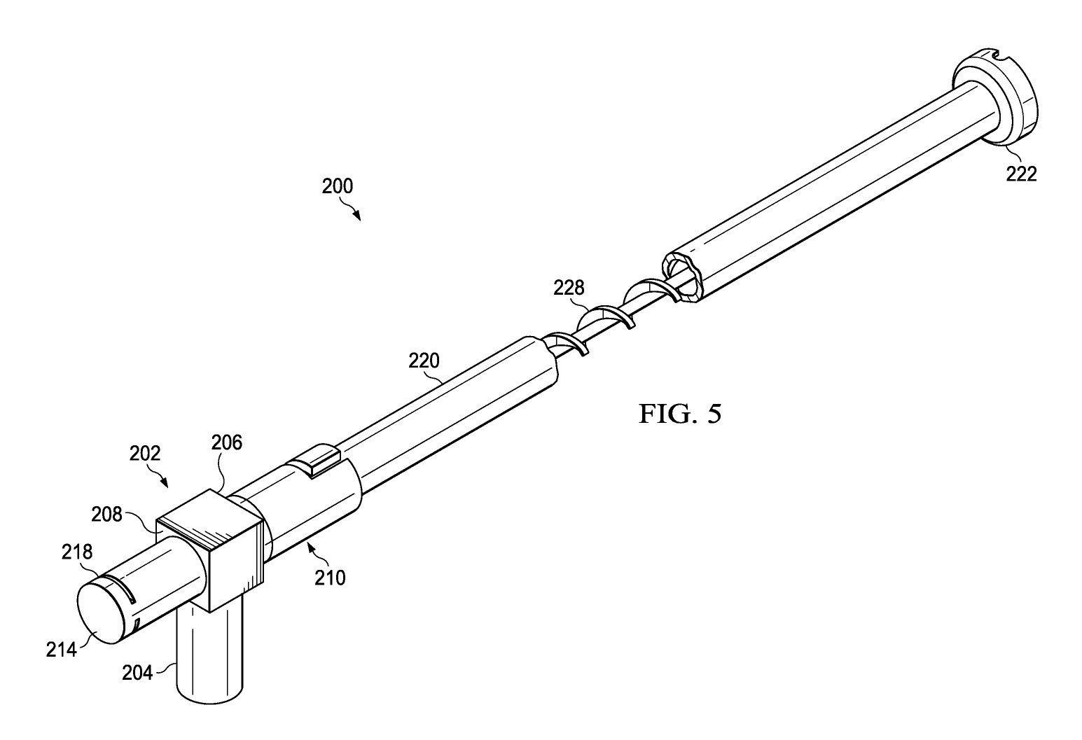

Referring back primarily to FIG. 3, a flanged nut 154 is threadably received on a distal end of body stem 128. Flanged nut 154 preferably defines an annular space 156. Nozzle barrel member 158 (FIGS. 3, 5) has a flange portion 159 that is received within annular space 156 of flanged nut 154.

Nozzle barrel member 158 defines a plurality of spray slits 160 for dispersing the fluids in a conical spray configuration or radial fan pattern. In one embodiment, two spray slits 160 are used, each traversing approximately 170° of the outer surface of nozzle barrel member 158. Greater or fewer spray slits 160 may also be used having a greater or reduced length, as desired. Spray slits 160 are preferably made with a slitting saw.

In use, a first fluid, e.g., a first polyurea component, is delivered into second passageway 24, 124. The first fluid passes through second passageway 24, 124 and into first passageway 22, 122 within circumferential passageway 36, 136 defined by right plug 32 or mixing cartridge 132. The first fluid then passes along a length of right plug 32 or mixing cartridge 132 within longitudinal passageway 38, 138, where the first fluid exits a distal end of right plug 32 or from right plurality of quasi-radial passageways 139 within fourth passageway 30.

A second fluid, e.g., a second polyurea component, is delivered into third passageway 26, 126. The second fluid passes through third passageway 26, 126 and into first passageway 22, 122 within circumferential passageway 44, 144 defined by left plug 32 or mixing cartridge 132. The second fluid then passes along a length of left plug 40 or mixing cartridge 132 within longitudinal passageway 46, 146, where the second fluid exits a distal end of left plug 40 of from left plurality of quasi-radial passageways 147 within fourth passageway 30.

The first fluid and second fluid impinge upon one another at ring orifice 48 formed by the adjacent distal ends of right plug 32 and left plug 40 or exit from center mixing ports 151. The first fluid and second fluid mix together to form a fluid disk.

A third fluid is delivered into center member 50, i.e., fourth passageway 30, 130. The third fluid passes through fourth passageway 30, 130, where it passes over the fluid disk and carries droplets of the mixed fluids further down fourth passageway 30, 130 into nozzle barrel member 58, 158. The mixed fluid then passes through radial orifices 64 and out circumferential spray gap 66 or out of spray slits 160 where the mixed fluids form a conical or radial spray pattern for delivering mixed fluids on an inside surface of a conduit or pipe.

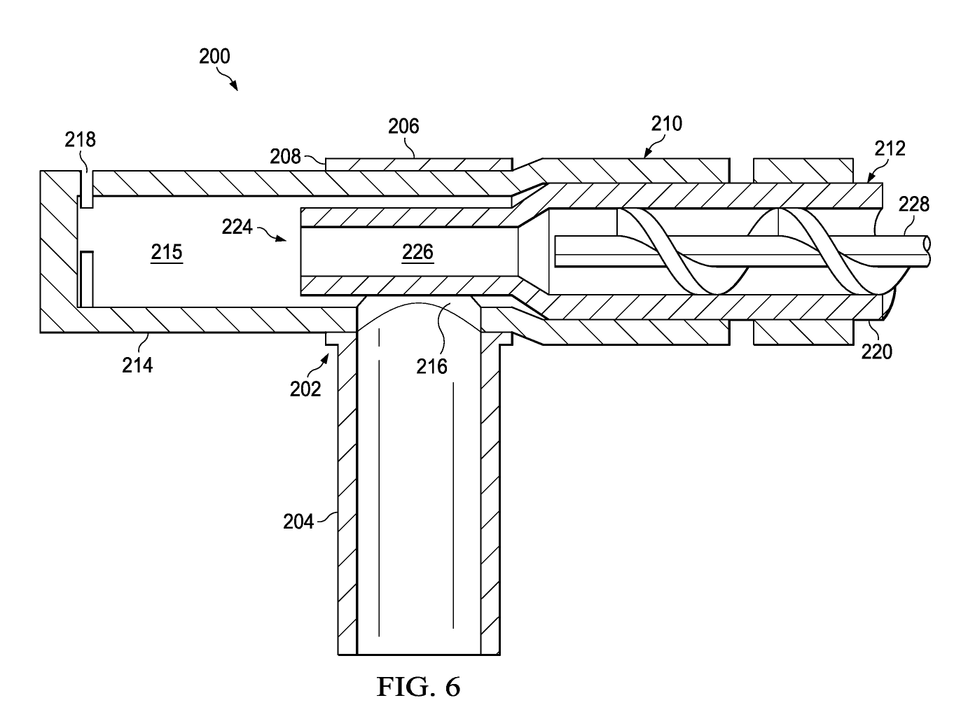

Referring now to FIGS. 5 and 6, shown is an additional embodiment 200 of the mixing apparatus of the invention. Embodiment 200 includes a fluid inlet member 202. Fluid inlet member 202 has an inlet tube 204 and a body structure 206. Body structure 206 defines a receiving orifice 208. As shown in FIG. 6, inlet tube 204 communicates with an inside of receiving orifice 208.

Nozzle member 210 is received within receiving orifice 208 of fluid inlet member 202. Nozzle member 210 has a receiving area 212 (FIG. 5) and defines a nozzle barrel 214. Nozzle barrel 214 defines mixing area 215. Nozzle barrel 214 defines an inlet orifice 216 (FIG. 6) and a plurality of spray slits 218.

Mixing tube 220 has an inlet end 222 (FIG. 5) and an outlet end 224 (FIG. 6). Tip 226 (FIG. 6) extends from outlet end 224. Outlet end 224 and tip 226 are received within receiving area 212 of nozzle member 210. Mixing auger 228 is housed within mixing tube 220.

In use, a first and a second fluid may be introduced into mixing tube 220 for thorough mixing by mixing auger 228. A third fluid may be introduced into inlet tube 204 of fluid inlet member 202 for passing through inlet orifice 216 for mixing with the mixed first and second fluids in the mixing area 215. The mixed first, second and third fluids are then dispersed out of spray slits 218.

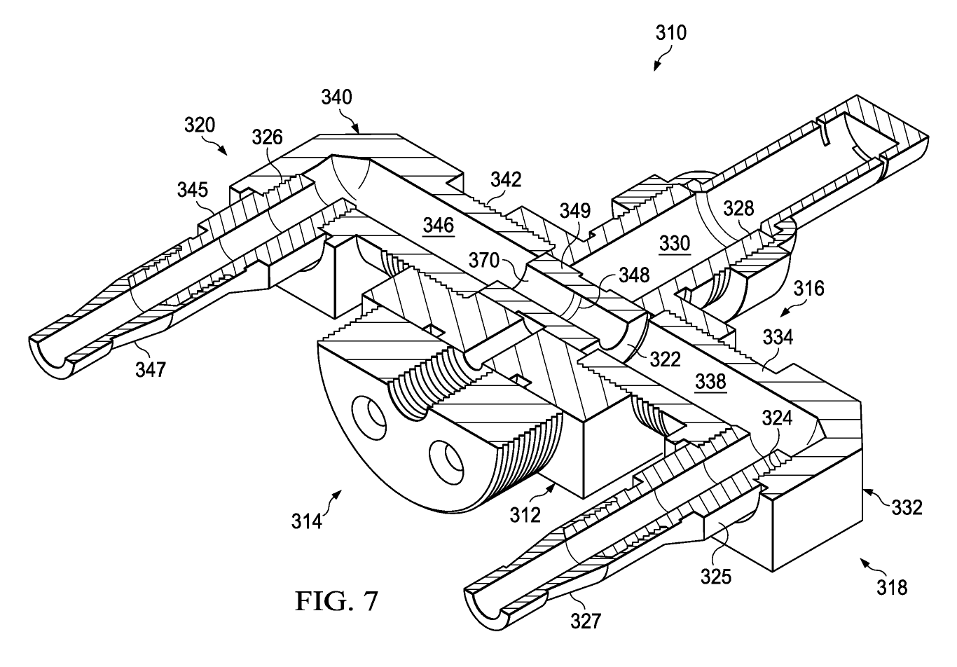

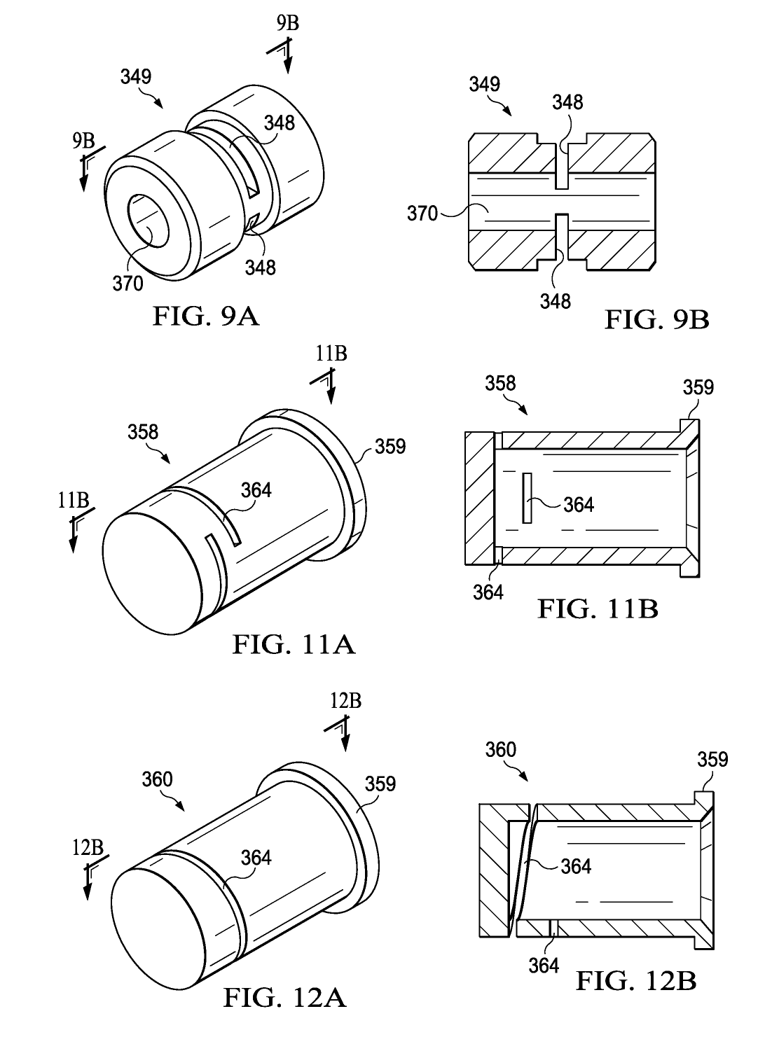

Referring now to FIGS. 7-12, shown is an additional embodiment of a plural component mixing nozzle designated generally 310. Nozzle 310 is made up of a body 312, having an inlet side 314, an exit side 316, a right side 318 and a left side 320. Body 312 defines a first passageway 322 that extends from right side 318 to left side 320 of body 312.

Body stem 328 extends from exit side 316 of body 312. Body 312 and body stem 328 define a fourth passageway 330 that passes through body stem 328 and body 312. Fourth passageway 330 may pass through a narrow portion such as fourth passageway slot 331 (FIG. 10A), which directs fluid over dispersing slots 348 of mixing cartridge 349, which is discussed below.

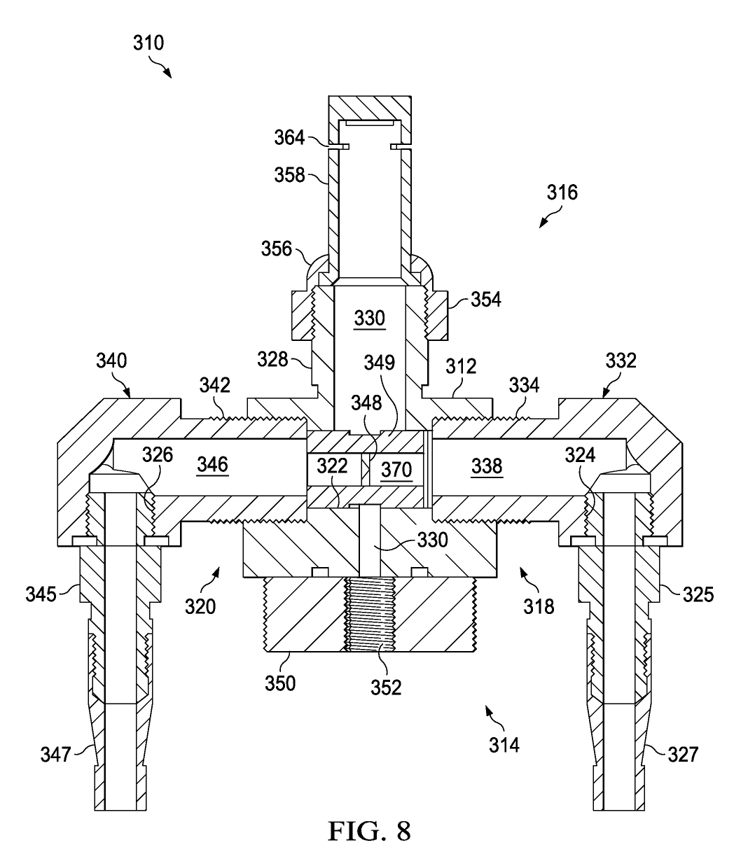

Right plug 332 is received in first passageway 322 at right side 318 of body 312. Right plug 332 has a stem 334 that is co-axial with first passageway 322. As shown in FIGS. 7 and 8, stem 334 of right plug 332 is inserted into first passageway 322. Right plug 332 defines second passageway 324. Right inlet member 325 communicates with second passageway 324. Right tip 327 engages a distal end of right inlet member 325. Right plug 332 further defines a longitudinal passageway 338 (FIGS. 7, 8) that communicates with second passageway 324 at a first end of longitudinal passageway 338 and communicates with a distal end of stem 334 at a second end of longitudinal passageway 338.

Left plug 340 is received in first passageway 322 at left side 320 of body 312. Left plug 340 has a stem 342 that is co-axial with first passageway 322. Stem 342 of left plug 340 is inserted in first passageway 322. Left plug 340 defines third passageway 326. Left inlet member 345 communicates with third passageway 326. Left tip 347 engages a distal end of left inlet member 345. Stem 342 of left plug 340 further defines a longitudinal passageway 346. Longitudinal passageway 346 communicates with second passageway 326 at a first end of longitudinal passageway 346 and communicates with a distal end of stem 342 at a second end of longitudinal passageway 346.

When right plug 332 and left plug 340 are installed within first passageway 322, distal end of stem 334 of right plug 332 and distal end of stem 342 of left plug 340 are located adjacent to an atomizing and blending cartridge, referred to herein as mixing cartridge 349 (FIGS. 7, 8, 9A, 9B). Mixing cartridge 349 defines dispersing slots 348 for dispersing fluids into fourth passageway 330. Slots 348 are preferably orientated perpendicular to the axis of cartridge 349. Slots 348 may be 0.013 ( 1/32) inch wide.

Mixing cartridge 349 is located in first passageway 322. Mixing cartridge 349 defines a longitudinal passageway 370 (FIGS. 7, 8, 9A, 9B) that communicates with an end of longitudinal passageway 338 of right plug 332 and communicates with an end of longitudinal passageway 346 of left plug 340. Fluids from right longitudinal passageway 338 and left longitudinal passageway 346 are blended when exiting mixing cartridge 349 from slots 348 by high velocity air that atomizes the two fluids during blending.

Center member 350 engages fourth passageway 330 on inlet side 314 of body 312. Center member 350 defines a center fluid inlet 352 for delivering a fluid into fourth passageway 330 for flowing past dispersing slots 348.

A nozzle sleeve 354 is threadably received on a distal end of body stem 328. Nozzle sleeve 354 preferably has a tapered outlet end 356. Nozzle barrel member 358 (FIGS. 7, 8, 11A, 11B) has a flange member 359 that is received within nozzle sleeve 354. In one embodiment, nozzle barrel member 358 defines four overlapping slots 364 (FIGS. 7, 8, 11A, 11B). In a preferred embodiment, four overlapping slots have an overlap of approximately 10 degrees. Emitting a three fluid blend perpendicular to an axis of the nozzle barrel was found to minimize disturbance of the coating as it formed on an interior of a conduit.

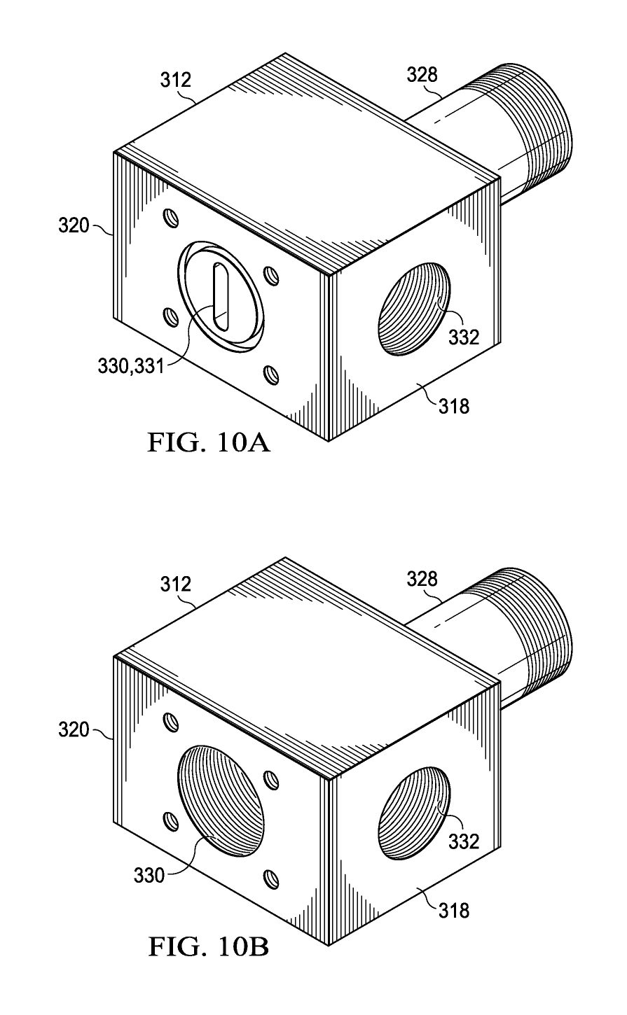

In a further embodiment, nozzle barrel member 360 (FIGS. 12A, 12B) defines a slot or slit 364 that traverses helically about barrel member 360. Preferably, helix or slot 364 has an approximately 10 degree overlap. Slots 364 may be cut with a 1/32 inch cut mill or, alternatively the barrel member will be molded in plastic.

In use, a first fluid, e.g., a first polyurea component, is delivered into second passageway 324. The first fluid passes through second passageway 324 through right longitudinal passageway 338 and into first passageway 327 of body 312 and into longitudinal passageway 370 of mixing cartridge 349. The first fluid then exits dispersing slots 348 of mixing cartridge 349.

A second fluid, e.g., a second polyurea component, is delivered into third passageway 326. The second fluid passes through third passageway 326 through left longitudinal passageway 346 and into first passageway 346 of body 312 and into longitudinal passageway 370 of mixing cartridge 349. The second fluid then exits dispersing slots 348 of mixing cartridge 349.

The first fluid and second fluid are blended in dispersing slots 348 of mixing cartridge 349.

A third fluid is delivered into center fluid inlet 352 of center member 350 for directing fluid into fourth passageway 330. The third fluid passes through fourth passageway 330, where it passes over the blend of first and second fluids exiting dispersing slots 348 of mixing cartridge 349. The third fluid may pass through a narrow portion such as fourth passageway slot 331 to focus the third fluid on the dispersing slots 348 of mixing cartridge 349. The third fluid carries droplets of the mixed fluids further down fourth passageway 330 into nozzle barrel member 358, 360. The mixed fluid then passes through radial orifices 364 where the mixed fluids form a conical or radial spray pattern for delivering mixed fluids on an inside surface of a conduit or pipe.

Although the embodiments of the apparatus are described to be used to mix and apply isocyanate and polymer resins forming the compound polyurea, the invention can be used to apply any plural material that reacts to form a compound to ducts and other pipes and tubing.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A plural component mixing nozzle comprising:
a body having an inlet side, an exit side, a right side and a left side, wherein said body defines a first passageway that extends from said right side to said left side;
said body further defining a second passageway communicating said inlet side with said first passageway proximate said right side and defining a third passageway communicating said inlet side with said first passageway proximate said left side;
a body stem extending from said exit side, wherein said body and said body stem define a fourth passageway that passes through said body from said inlet side to said exit side and passes through said body stem;
a mixer in said first passageway for mixing a fluid from said second passageway and a fluid from said third passageway and directing a mixture of said fluids into said fourth passageway;
an exit nozzle on a distal end of said body stem.

2. The mixing nozzle according to claim 1 wherein:
said mixer is a mixing cartridge.

3. The mixing nozzle according to claim 2 wherein:
said mixing cartridge defines dispersing slots for dispersing fluid from said first passageway and said second passageway into said fourth passageway.

4. The mixing nozzle according to claim 3 wherein:
said dispersing slots of said mixing cartridge are oriented perpendicularly to a longitudinal axis of said mixing cartridge.

5. The mixing nozzle according to claim 1 wherein:
said fourth passageway is provided with a narrowed portion for directing fluid over said mixer.

6. The mixing nozzle according to claim 2 wherein:
said mixing cartridge is received in said first passageway, said mixing cartridge defining a right mixer passageway inlet that communicates with said second passageway and said mixing cartridge further defines a right longitudinal mixer passageway that communicates with said right mixer passageway inlet proximate a first end of said right longitudinal mixer passageway and communicates with a first plurality of mixer exit passageways proximate a center of said mixing cartridge at a second end of right longitudinal mixer passageway;
said mixing cartridge further defining a left mixer passageway inlet that communicates with said third passageway, said mixing cartridge further defining a left longitudinal passageway that communicates with said left mixer passageway inlet proximate a first end of said left longitudinal passageway and communicates with a second plurality of mixer exit passageways proximate said center of said mixing cartridge at a second end of said left longitudinal passageway.

7. The mixing nozzle according to claim 6 further comprising:
a right stopper secured at a right end of said first passageway;
a left stopper secured to a left end of said first passageway;
said left stopper and said right stopper for securing said mixing cartridge within said first passageway of said body.

8. The mixing nozzle according to claim 6 wherein:
said first plurality of mixer exit passageways and said second plurality of mixer exit passageways meet at common mixer ports defined by an external surface of said mixing cartridge, said mixer ports for distributing mixed fluid from said mixing cartridge in an approximately disk-shaped fluid pattern.

9. The mixing nozzle according to claim 8 wherein:
said left longitudinal passageway and said right longitudinal passageway are separated from one another by a partition.

10. The mixing nozzle according to claim 8 wherein:
fluid enters into said fourth passageway proximate said inlet side of said body for flowing past said approximately disk-shaped pattern formed by fluid exiting from said mixer ports.

11. The mixing nozzle according to claim 8 wherein:
said first plurality of mixer exit passageways and said second plurality of mixer exit passageways are oriented at an approximately 30° angle from a plane that is perpendicular to a longitudinal axis of said mixing cartridge.

12. The mixing nozzle according to claim 1, further comprising:
a center member received in said fourth passageway on said inlet side of said body, said center member defining a center fluid inlet for delivering a fluid into said fourth passageway and toward said mixer.

13. The mixing nozzle according to claim 1 wherein:
said exit nozzle is a nozzle sleeve threadably received on a distal end of said body stem, said nozzle sleeve having a tapered outlet end.

14. The mixing nozzle according to claim 1 wherein said:
exit nozzle defines a spiral shaped exit slot.

15. The mixing nozzle according to claim 1 wherein:
said exit nozzle defines a plurality of spray slits for dispersing the fluids in a conical spray configuration or radial fan pattern.

16. The mixing nozzle according to claim 1 wherein:
said exit nozzle defines a plurality of spray slits for dispersing the fluids in a conical spray configuration or radial or disk shaped pattern.

17. The mixing nozzle according to claim 16 wherein:
said plurality of spray slits have overlapping portions.

18. The mixing nozzle according to claim 17 wherein:
said overlapping portions have an overlap of approximately 10 degrees.

19. The mixing nozzle according to claim 1 wherein:
said exit nozzle has a helical spray slit for dispersing fluid.

20. The mixing nozzle according to claim 19 wherein:
said helical spray slit has overlapping ends.

21. The mixing nozzle according to claim 20 wherein:
said overlapping ends have an overlap of approximately 10 degrees.

22. The mixing nozzle according to claim 16 wherein:
said plurality of spray slits comprise two spray slits, each of said spray slits traversing approximately 170° of an outer surface of said nozzle barrel member.

23. A mixing apparatus comprising:
a fluid inlet member having an inlet tube and a body structure wherein said body structure defines a receiving orifice, and wherein said inlet tube communicates with said receiving orifice;
a nozzle member received within said receiving orifice of said fluid inlet member, said nozzle member having a receiving area and a nozzle barrel defining an inlet orifice, said nozzle barrel defining a plurality of spray slits therein;
a mixing tube having an inlet end and an outlet end and a tip extending from said outlet end, wherein said outlet end and said tip are received within said receiving area of said nozzle member;
a mixing auger housed within said mixing tube;
wherein a first and a second fluid may be introduced into said mixing tube for thorough mixing by said mixing auger and wherein a third fluid may be introduced into said inlet tube of said fluid inlet member for mixing with said mixed first and second fluids for dispensing said first, second and third fluids out of said spray slits.
